(19) United States
(12) Patent Application Publication
(10) Pub. No.: US 2004/0214707 A1
(43) Pub. Date: Oct. 28, 2004

(54) Method for further processing printed sheets

(75) Inventors: Klaus Stocklossa, Marbach (DE); Eberhard Krieger, Weinstadt-Struempfelbach (DE)

Correspondence Address: ROTHWELL, FIGG, ERNST & MANBECK, P.C., 1425 K STREET, N.W., SUITE 800, WASHINGTON, DC, 20005, US

(73) Assignee: Maschinenbau Oppenweiler Binder GmbH & Co. KG, Oppenweiler (DE)

(21) Appl. No.: 10/839,178

(22) Filed: May 6, 2004

(30) Foreign Application Priority Data
Jul. 17, 2003 (DE) 103 32 618.9
May 8, 2003 (EP) 03 010 429.3
Sep. 25, 2003 (DE) 103 44 577.3

(51) Int. Cl. B31F 1/10

(52) U.S. Cl. 493/405

(57) ABSTRACT

In the method for further processing sheets printed in particular by a digital press for the production of multi-sheet printed products, the printed sheets are folded at least once by at least one folder to form a folded sheet and the folded sheets are collated one above another in a gathering device. The sheets are provided with detection features to be detected by a detection device and the detection device passes on signals corresponding to the detection features to a central control device, which controls at least one folder and/or the gathering device in accordance with the detection features.

### FIELD OF THE INVENTION

The invention relates to a method for further processing sheets printed in particular by a digital press for the production of multi-sheet printed products.

### DESCRIPTION OF THE BACKGROUND ART

An apparatus DE 102 20 550 A1 has a pocket folder, by means of which a sheet is folded transversely with respect to the sheet running direction. The pocket folder is followed by a blade folder, which folds the sheet coming from the pocket folder in the sheet running direction, by a folding blade inserting the sheet between two folding rolls that can be rotated in opposite directions. Arranged underneath the folding rolls is a feed drum, which picks up the folded sheet by means of a gripper. Underneath the feed drum there is arranged a sheet opener formed by two transport rolls that can be rotated in opposite directions. Underneath the sheet opener there is a transport rail, on which the opened sheets can be deposited one above another. The sheets folded by the blade folder run through the blade folder in such a way that the folded edge is at the bottom and the sheet opens at the top. By means of the feed drum, the sheet is rotated such that the folded edge is at the top and the sheet opens at the bottom, in order that it can be deposited on the transport rail. The sheet is not checked on the sheet stack with regard to its suitability for a specific job. It is therefore possible for a sheet to be assigned to the wrong job or even for an unprinted sheet to be further processed.

### SUMMARY OF THE INVENTION

The invention is based on the idea of providing a method which permits fault-free and flexible job production.

According to the invention, this object is achieved by a method for further processing sheets printed in particular by a digital press for the production of multi-sheet printed products, in which said printed sheets are folded at least once by at least one folding device to form folded sheets and said folded sheets are collated in a gathering device, wherein said sheets are provided with detection features to be detected by a detection device and said detection device passes on signals corresponding to said detection features to a central control device, which controls said at least one folding device and/or said gathering device in accordance with said detection features.

The method according to the invention permits fault-free and flexible job production since, as a result of the detection features, accurate assignment of a sheet to a job is possible.

### BRIEF DESCRIPTION OF THE DRAWINGS

Exemplary embodiments of the invention will be explained in more detail below using drawings, in which:

FIG. 1 shows schematically a side view of an apparatus for the further processing of printed sheets for producing multi-sheet printed products,

FIG. 2 shows schematically the individual operations of the apparatus according to the invention, a sheet being folded by a pocket folder,

FIG. 3 shows the individual operations of the apparatus, a sheet passing through the pocket folder without being folded.

### DETAILED DESCRIPTION OF THE INVENTION

The apparatus according to the invention has a sheet feeder 12, on which a plurality of sheet stacks 13 are arranged one above another. Each sheet stack 13 comprises a large number of sheets which are printed on their top side and on the underside by a digital press. The sheet feeder 12 is followed by an alignment table 16 for aligning and feeding a sheet to a pocket folder 18 having two folding pockets 20, 22. The pocket folder 18 is followed by a former folder 24, which is arranged in such a way that it opens downward. In the sheet running direction BL, the former folder 24 is followed by a gathering device 26, known per se, having a chain on which the folded sheets are gathered. The gathering device 26 is followed by an apparatus 28 for placing a cover over the sheets collated by the gathering device 26. After that, a jogger 30 is provided, which aligns the sheets together with the cover. The jogger 30 is followed by a binding device 32, which binds the sheets and the cover together. This is followed by a cutting device 34, which cuts the three sides of the sheets which are not bound. The cutting device 34 is then followed by a delivery 36 and a perforating device 38.

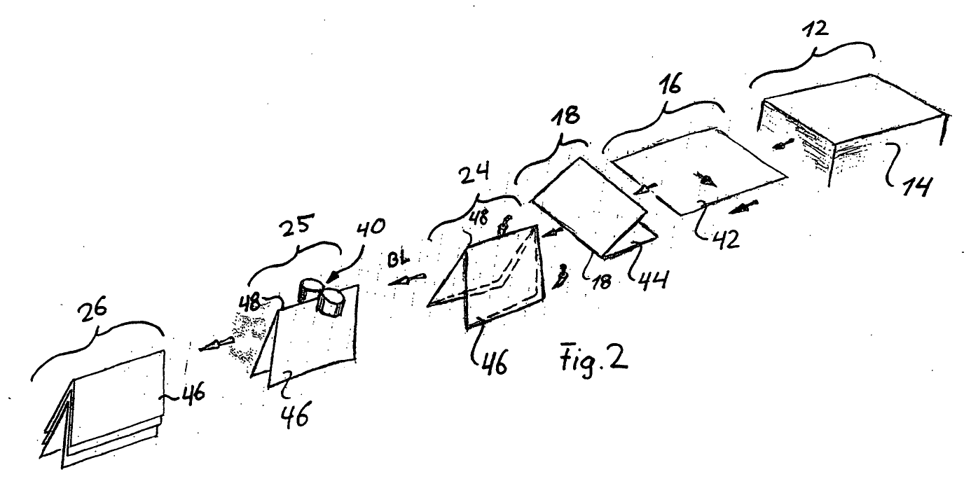

The individual operations of the apparatus according to the invention are shown in FIG. 2. A sheet 42 is removed from the sheet stack 13 of the sheet feeder 12 and is aligned on the alignment table 16. In the pocket folder 18, the sheet 42 is folded transversely with respect to the sheet passage direction BL to form a first folded sheet 44. The folded sheet 44 leaves the pocket folder 18 with the folded edge 45 leading and is fed to the former folder 24, which folds the first folded sheet 44 to form a second folded sheet 46, whose folded edge 48 extends upward horizontally in the sheet running direction BL, the second folded sheet 46 opening at the bottom in such a way that the lower edges of the second folded sheet 46 are arranged at a distance from each another.

As can be seen in FIG. 2, after the former folder 24 a pressing device 25 can also be provided, which has a pair of press rollers 40 which press the folded edge 48 of the second folded sheet 46 leaving the former folder 24. Following the pressing device 25, the folded second folded sheets 46 are deposited one above another in the gathering device 26. The operations described in FIG. 2 are used for folding sheets on which eight pages of the finished multi-sheet printed product are printed.

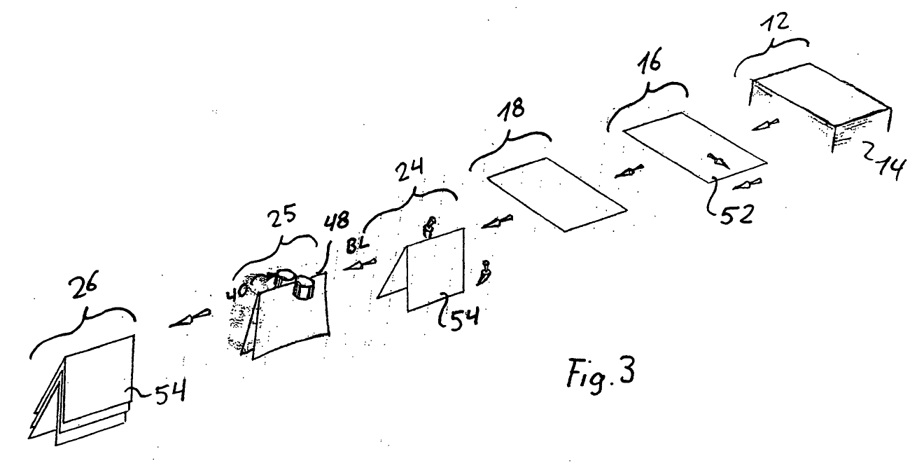

If only four pages of the finished printed product are printed on the sheets removed from the sheet feeder 12, the operations shown in FIG. 3 are carried out. These differ merely in the fact that the sheet 52 removed from the sheet stack 13 and aligned on the alignment table 16 passes through the pocket folder 18 without being folded. In the former folder 24, the sheet is folded for the first time about a fold line extending in the sheet running direction BL to form a first folded sheet 54. All the further operations correspond to the operations shown in FIG. 2.

As the FIGS. 2 and 3 show, a change in the position of the sheets 46, 54 after leaving the former folder 24 in order to be deposited in the gathering device 26 is not necessary, which means that the production output can be increased.

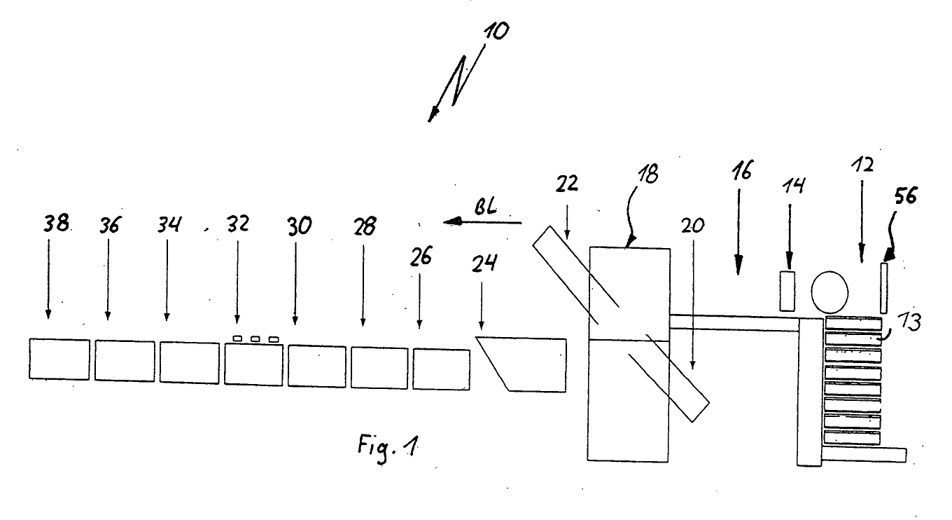

As shown in FIG. 1, a bar code reader 26 is arranged above the sheet stack 13 as a detection system which is suitable for the detection of bar codes which are printed onto the sheets by the digital press. The bar code reader passes on signals corresponding to a detection to a central control device of the apparatus according to the invention.

The bar codes can contain 12 places, for example, which are divided up into the following detection features:

Places 1+2=consecutive sheet number in the book

Places 3+4=number of folded sheet pages in the book

Places 5+6+7+8+9=job number (job ID including language variant)

Place 10=counting direction (0=rising, 1=falling)

Place 11=counting step width (1 . . . 2)

Place 12=number of pages on sheets

0=4 pages

1=8 pages

2=12 pages

3=16 pages

4=20 pages

5=24 pages

6=28 pages

7=32 pages

8=36 pages

9=40 pages

The following tasks can be fulfilled by the detection features.

The number of folded sheet pages in the book block can be determined. For this purpose, a setting relating to the part preselection in the counter for producing the sheet spacing can be set via the marking type “marking on the suction wheel”. Together with the information relating to “counter step width” and “number of pages on sheets”, it is then possible to determine the number of sheet parts of which the book block is composed. The binder is set appropriately.

It is then possible to check whether the book is complete and whether the order of the sheets agrees. The sheet feeder can also be controlled. A bar code must be able to be read as far as the trigger end. If this is not the case, then “NOREAD” information appears directly on the reader. In addition, a check is made to check whether the triggering of the marking is synchronized with the book.

It is possible to count differently, depending on the setting parameters “counting direction” and “counting steps”. This is necessary since the following methods should be possible in order to obtain the flexibility:

definition of the internal company designation methodology characteristics of the bar code software used characteristics of the prepress stage used.

Finally, it is possible to monitor whether an activated job number agrees with the sheets.

The bar code monitoring of the sheets permits various operating modes.

In a mode 0—“Off” there is no bar code. The setting is carried out via a counting means on the feeder. In this case, the function is that of a standard folder. Parameter changes via configuration of the marking are possible in this case. No clock triggering is carried out on the binder.

In a mode 1—“Free run mode” there is likewise no bar code and the setting is carried out via a counting means on the feeder. In this case, it will be assumed that at a “CONTINUOUS SHEET START” the first sheet of a block always lies on the top. However, this means that, following a stoppage for any reason, without a sheet having been removed from the machine, an individual sheet must be called off until a first sheet is again on the top of the feed stack. Parameter changes via configuration of the marking are not possible. This is therefore a very unsafe method, since no kind of monitoring is possible to see whether all sheets are present and whether, in the event that sheets are lacking, the correct order of the sheets is present. Nor is any clock triggering carried out on the binder.

In a mode 2—“Trigger mode” there is a bar code only on the last sheet of a book. On the folder, the number of sheets per book is entered. If this does not agree with the marking, then an error message is output.

In a mode 3—“Safety mode with the same job” a bar code is applied to every sheet. This makes safe checking for misfed sheets possible. When counting the bar code, a start is always made with the first or the last odd number (if counting step width=2).

In a mode 4—“Safety mode 2 with alternating job” there is likewise a bar code on every sheet, so that safe checking for misfed sheets is possible. When counting the bar code, a start is always made with the first or the last odd number (if counting step width=2).

If the plant is running in mode 4 then, following the detection of a “new job”, the folder will first of all be idled and then the clock will be triggered. After the binding clock cycle has elapsed, the new “job number” and the “number of pages in this book” will be transmitted. As soon as the binder reports “adjustment completed”, a new start is possible.

In the modes 3 and 4, it is possible, in continuous operation and specifically always in conjunction with a new job, that the number of folded sheets which belongs to this job can differ from the number from the previous job and the folder is adapted automatically. It is ensured that only complete signatures are located on the gathering station. The control of the sheet haul-off at the sheet stack is adapted. It is possible, in continuous operation and specifically always in conjunction with a new job, for the counting direction which belongs to this job to be able to differ from the previous counting direction, the folder being adapted automatically. It is possible to count upward and downward, for example 1/2/3/4/5//1/2 . . . or 5/4/3/2/1//5/4. . . ). In addition, it is ensured that the order of the sheets in the signature is correct (sheet 2 comes after sheet 1, and so on). Different step widths are possible, for example +1 +2 . . . , −1 −2 . . . etc.

Each signature starts, for example, with a starting sheet having the following codes:

Step width=1 counting direction=(+) number of folded sheets=5 starting sheet=“1”/2/3/4/5//“1” . . .

Step width=1 counting direction=(−) number of folded sheets=5 starting sheet=“5”/4/3/2/1 //“5” . . .

Step width=2 counting direction=(+) number of folded sheets=5 starting sheet=“1”/3/5/7/9//“1”/.

Step width=2 counting direction=(−) number of folded sheets=5 starting sheet=“9”/7/5/3/1//“9”/.

An inspection is made to see whether the sheet position of each individual sheet is correct, since each sheet has a bar code and the latter also has to be read. If it cannot be read, then the sheet has been placed the wrong way round on the feeder. This prevents an unprinted sheet in the stack from being processed. Since the job number is stored in the bar code and each sheet must be part of the active job, a check is made to see whether each sheet also belongs to this job.

A job change can be performed automatically. If the first sheet has a new job number, then the reference job number is new.

If a change in the job number is detected on the folder, this information is transmitted automatically to the binder. The binder checks in the correct cycle whether the folded sheet fed in belongs to the stack and whether the cover fed in belongs to the stack. In addition, in continuous operation and always in conjunction with a new job, it is possible that the number of sheets which belongs to this job is able to differ from the previous one. The folder is adapted automatically. The binder can automatically readjust the trim thickness of a trimmer in the correct cycle.

The choice of the mode depends on whether software stored in the control device for creating the bar codes is capable of writing to all the defined fields or not.

The detection features can also be applied as a data matrix code or the like instead of as a bar code, an appropriate detection device being required for this purpose. Likewise, clear text identification is also possible.

In the exemplary embodiment described, the sheets are fed by a sheet feeder. However, other feed devices are also possible. For example, the sheets can also be fed directly from a digital press. Instead of a binder, a gathering pocket can also be used, in which the individual sheets are gathered, bound and then folded.

What is claimed:

1. A method for further processing sheets printed in particular by a digital press for the production of multi-sheet printed products, in which said printed sheets are folded at least once by at least one folding device to form folded sheets and said folded sheets are collated in a gathering device, wherein said sheets are provided with detection features to be detected by a detection device and said detection device passes on signals corresponding to said detection features to a central control device, which controls said at least one folding device and/or said gathering device in accordance with said detection features.

2. The method as claimed in claim 1, wherein one or more of said following detection features are provided on said sheets:
consecutive sheet number in said printed product
folded sheet pages in said printed product
job number
counting direction
counting step width
pages on sheets
sheet thickness
with/without cover feeder in a binder
number of folded sheet feeders in a binder
personalization data.

3. The method as claimed in claim 1, wherein said detection features are applied to said sheet as a bar code and a bar code reader is used as a detection device.
